(19) United States
(12) Patent Application Publication
(10) Pub. No.: US 2014/0085873 A1
(43) Pub. Date: Mar. 27, 2014

(54) Style Tyle

(71) Applicant: Nolan Willis, Bremerton, WA (US)

(72) Inventor: Nolan Willis, Bremerton, WA (US)

(21) Appl. No.: 14/017,777

(22) Filed: Sep. 4, 2013

Related U.S. Application Data
(60) Provisional application No. 61/704,129, filed on Sep. 21, 2012.

(51) Int. Cl. F21V 33/00

(52) U.S. Cl. CPC F21V 33/006
USPC 362/145

(57) ABSTRACT

An illuminated tile device is disclosed that provides a simplified method of applying LED lighting so it can be used in residential and small-scale spaces. The illuminated tile device comprises a base layer, a top layer, and a plurality of light emitting diodes (LEDs) sandwiched there between. Furthermore, the gap between the top layer and the base layer comprises a filler material wherein the plurality of LEDs are embedded. The plurality of LEDs are in electrical communication via at least one electrical trace interconnecting the plurality of LEDs in series between two sets of electrical contacts positioned on perimeter edges of the base layer. The electrical contacts allow for the interconnection of multiple illuminated tile devices and enable electrical continuity between the devices and from a modulated power source. Additionally, a plurality of illuminated tile devices can be interconnected and secured together within a grid.

### CROSS-REFERENCE

This application claims priority from Provisional Patent Application Ser. No. 61/704,129 filed Sep. 21, 2012.

### BACKGROUND

Most currently available lighted tile systems are too complex and/or costly for residential or widespread design applications. Additionally, the lack of illuminated flooring or other tiling limits decorative options and can lead to messes, accidents, and injuries in poorly lit areas. An effective solution is necessary.

The present invention adds extra illumination to areas with dim or poor lighting and provides a simplified method of applying decorative LED lighting to tiling so that it can be used in residential and small-scale spaces. The illuminated tile device and system also decreases the cost of installing and maintaining LED tiles while resisting scratching and breakage of the tiles so that the tile system can be used in flooring. Thus, this device allows users to use LED lights more effectively for home and commercial design purposes.

### SUMMARY

The following presents a simplified summary in order to provide a basic understanding of some aspects of the disclosed innovation. This summary is neither an extensive overview nor is it intended to identify key/critical elements or to delineate the scope thereof. The summary's sole purpose is to present some concepts in a simplified form as a prelude to the more detailed description that is presented later.

The subject matter disclosed and claimed herein, in one aspect thereof, comprises an illuminated tile device that provides a simplified method of applying LED lighting to tiling so that it can be used in residential and small-scale spaces. The illuminated tile device comprises a base layer, a top layer, and a plurality of light emitting diodes (LEDs) placed between the base layer and the top layer wherein the plurality of LEDs are in electrical communication with one another and a power source. The LEDs can be one color, a series of colors, or even be arranged in a pre-defined pattern of multiple colors. Typically, the LEDs are located a small distance (typically, between 1 mm and 3 mm) beneath the bottom surface of the top layer and are secured directly to the top surface of the bottom layer. The top and bottom layers are parallel with respect to each other, and the gap between the two layers is filled with a filler material thereby fusing or cementing the top and bottom layers to form a tile with embedded LEDs and a glossy façade. The plurality of LEDs are in electrical communication via at least one electrical trace interconnecting the plurality of LEDs in series between two sets of electrical contacts positioned on perimeter edges of the base layer. The electrical contacts allow for the interconnection of multiple illuminated tile devices and enable electrical continuity between the devices and from a power source. A current limiting or regulating device may be integrated and placed in series with each set of LEDs to ensure proper current draw.

In a preferred embodiment, the illuminated tile devices can be electrically interconnected together using conductive contact clips and secured into molded or extruded grid patterns using retaining clips to form an illuminated tile array. The purpose of the grid is to both align the devices and hold the conductive contact clips in place between the devices. The grid may be cemented, glued, or otherwise attached to a solid surface. Further, the illuminated tile system requires a power supply and/or a pulse width modulation controller connected between the tile array and the input power. The power supply and/or controller would convert standard residential AC (alternating current) power into pulse-width-modulated DC (direct current) power used to control the brightness and/or pattern of the tile array.

To the accomplishment of the foregoing and related ends, certain illustrative aspects of the disclosed innovation are described herein in connection with the following description and the annexed drawings. These aspects are indicative, however, of only a few of the various ways in which the principles disclosed herein can be employed, and this summary is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the illuminated tile device in accordance with the disclosed architecture.

FIG. 2A illustrates a perspective view of a plurality of interconnected illuminated tile devices in accordance with the disclosed architecture.

FIG. 2B illustrates a perspective view of a plurality of interconnected illuminated tile devices secured with a retaining clip in accordance with the disclosed architecture.

FIG. 3 illustrates a perspective view of a plurality of interconnected illuminated tile devices with one secured in a grid in accordance with the disclosed architecture.

FIG. 4 illustrates a perspective view of a plurality of interconnected illuminated tile devices prior to being inserted into a grid in accordance with the disclosed architecture.

FIG. 5 illustrates a perspective view of the illuminated tile system in accordance with the disclosed architecture.

FIG. 6 illustrates one embodiment of an electronic schematic of the illuminated tile system in accordance with the disclosed architecture.

FIG. 7 illustrates a perspective view of the illuminated tile system in use on a wall in accordance with the disclosed architecture.

FIG. 8 illustrates a perspective view of the illuminated tile system in use on a floor in accordance with the disclosed architecture.

### DESCRIPTION OF PREFERRED EMBODIMENTS

The innovation is now described with reference to the drawings wherein like reference numerals are used to refer to like elements throughout. In the following description, for purposes of explanation, numerous specific details are set forth in order to provide a thorough understanding thereof. However, the fact that this innovation can be practiced without these specific details may be evident. Otherwise, well-known structures and devices are shown in block diagram form in order to facilitate a description thereof.

The present invention provides extra illumination to areas with dim or poor lighting and provides a simplified method of applying decorative LED lighting to tiling (floor and wall tiling in particular) so it can be used in residential and small-scale spaces. The illuminated tile device and system also decreases the cost of installing and maintaining LED tiles while resisting scratching and breakage of the tiles so that the system can be used in flooring. Thus, this device allows users to use LED lights more effectively for home and commercial design purposes.

The disclosed illuminated tile device comprises a base layer, a top layer, and a plurality of light emitting diodes (LEDs) installed between the two layers. The LEDs, associated traces, and components are embedded within a suitable filler material to form a structural matrix between the top and bottom layers and to protect the LEDs from abuse. The plurality of LEDs are also connected in series with one another, with a current regulating device (if used), and with the electrical contacts positioned on a perimeter edge of the base layer (to allow for the interconnection of multiple illuminated tile devices with a common power supply and/or with a pulse width modulation controller). Additionally, a plurality of illuminated tile devices can be interconnected and secured together within a grid to form a tile array.

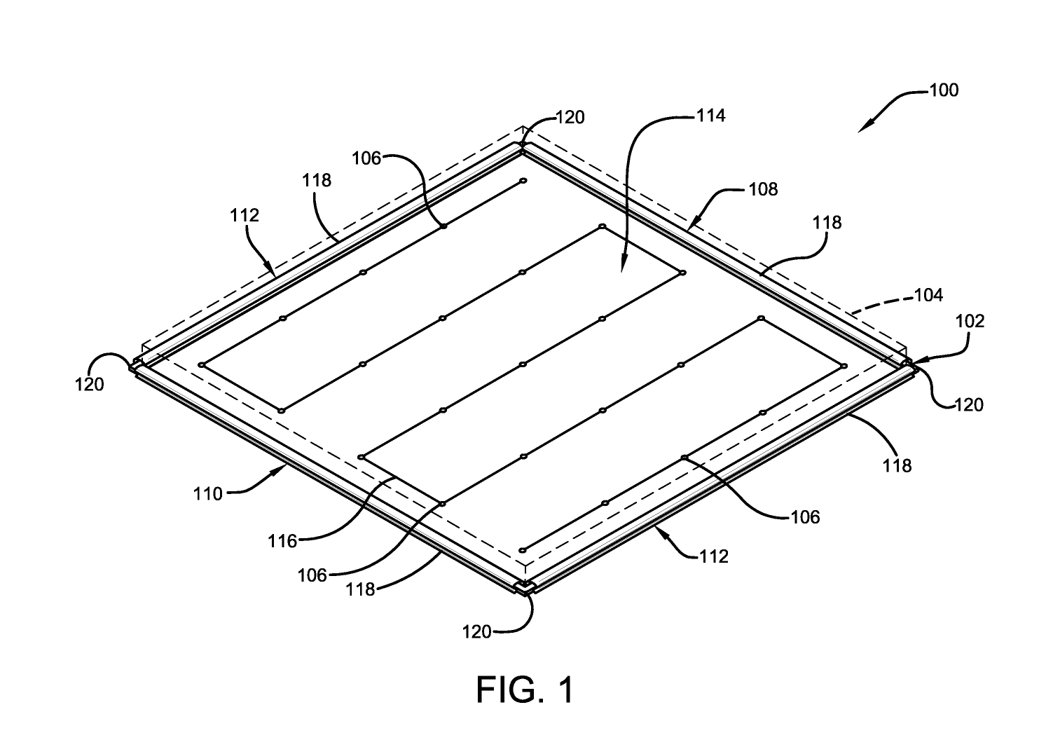

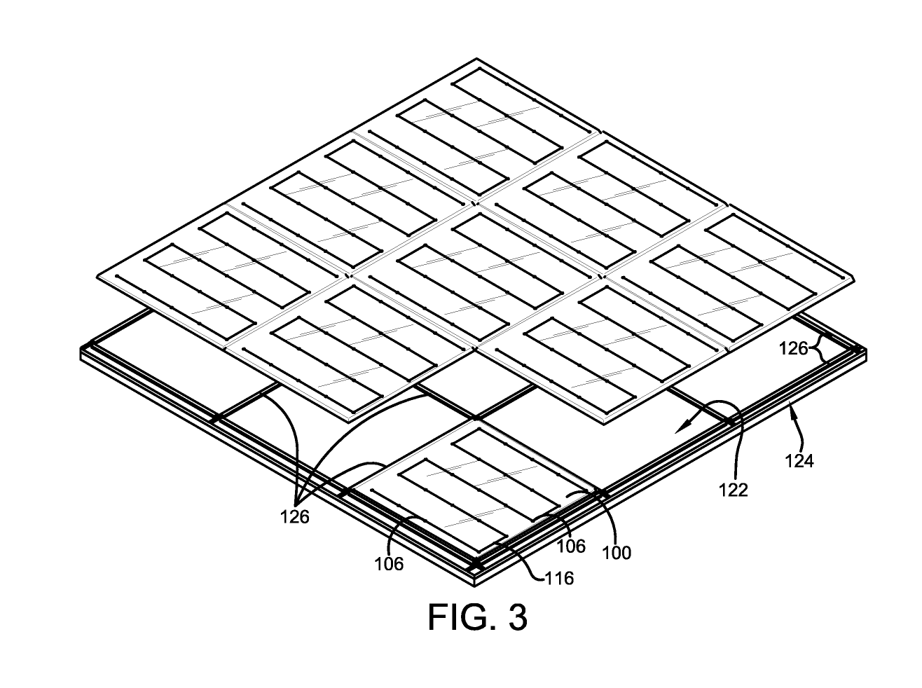

Referring initially to the drawings, FIGS. 1, 2A-2B, and 3-6 illustrate the illuminated tile device 100 that provides a simplified method of applying LED lighting to tiling so that it can be used in residential and small-scale spaces. The illuminated tile device 100 comprises a base layer 102, a top layer 104, and a plurality of light emitting diodes (LEDs) 106 wherein the plurality of LEDs 106 are in electrical communication (as shown in FIG. 1) with one another, an optional current limiting device, and a power source.

The base layer 102 and the top layer 104 both comprise a first end portion 108, a second end portion 110, opposing sides 112, a top surface 114, and a bottom surface (not shown). Typically, the base layer 102 and the top layer 104 can be any suitable shape as is known in the art without affecting the overall concept of the invention (e.g., rectangular, square, etc.) as long as the base layer 102 is substantially the same shape and size as the top layer 104. The base layer 102 and the top layer 104 would generally be constructed of a scratch-resistant and shatter-resistant glass, plexi-glass, acrylic, polycarbonate, ceramic, etc. though any other suitable material may be used to manufacture the base layer 102 and the top layer 104 as is known in the art without affecting the overall concept of the invention.

In a typical example, the top layer 104 would be transparent to both visible and UV light so that UV LEDs could also be installed instead of regular LEDs. The tile devices 100 can then be embedded with a fluorescent dye of some kind to produce tile devices 100 that glow rather than sparkle when energized. Also, the top layer 104 may be etched to give a “frosty” appearance. Further, the top layer 104 could be ceramic with small artistically shaped glass windows allowing the light to shine through thereby forming various decorative shapes. The LEDs could then be positioned directly beneath each of the windows in small clusters. Additionally, the top layer 104 could be ceramic with short optical fibers running from the upper surface down into the base layer 102. This would enable the tile devices 100 to look like conventional tiles, but once energized, the tile devices 100 would produce a starry or sparkly appearance. Furthermore, any combination of the above methods may be employed in a single tile.

The base layer 102 and the top layer 104 can also comprise a variety of colors and designs to suit user and manufacturing preference. While the shape and size of the base layer 102 and the top layer 104 may vary greatly depending on the wants and needs of an user and depending on the size and function of the surface being covered, the base layer 102 and the top layer 104 are approximately between 25 mm and 300 mm long as measured from the first end portion 108 to the second end portion 110, approximately between 25 mm and 300 mm wide as measured from opposing sides 112, and approximately between 1 mm and 6 mm thick as measured from a top surface 114 to a bottom surface (not shown). Further, the base layer 102 and the top layer 104 can be different thicknesses from each other, and the top layer 104 is likely to be smaller than the base layer 102 (in terms of length and width) in order to allow the edges of the base layer 102 to protrude into the contact clips 126.

The illuminated tile device 100 further comprises a plurality of light emitting diodes (LEDs) 106 installed between the base layer 102 and the top layer 104. Typically, the base layer 102 and the top layer 104 are secured offset from and parallel to each other by the filler material placed between the two layers. Further, the plurality of LEDs 106 comprises any suitable number or type of LEDs as is known in the art and according to user and manufacturer preference and/or need. The LEDs can be one color, a series of colors, or even be arranged in a pre-defined pattern of multiple colors to suit user preference or a particular application.

Typically, the space between the top layer 104 and the base layer 102 is filled with a filler material for the purposes of bonding or fusing the top and base layers (104 and 102 respectively) together; forming a matrix wherein the LEDs 106, circuit traces, and associated components reside (thereby potentially strengthening the bond between the top 104 and the bottom 102 layers); and forming a matrix for dyes, glass beads, glitter, or any other decorative media to enhance the tile's aesthetics. This filler material may be cement, glue, acrylic, epoxy, or any other suitable material. Typically, the top layer 104 and the filler material are substantially transparent to both visible and UV light (so that UV LEDs could also be installed instead of regular LEDs) to create a glossy façade.

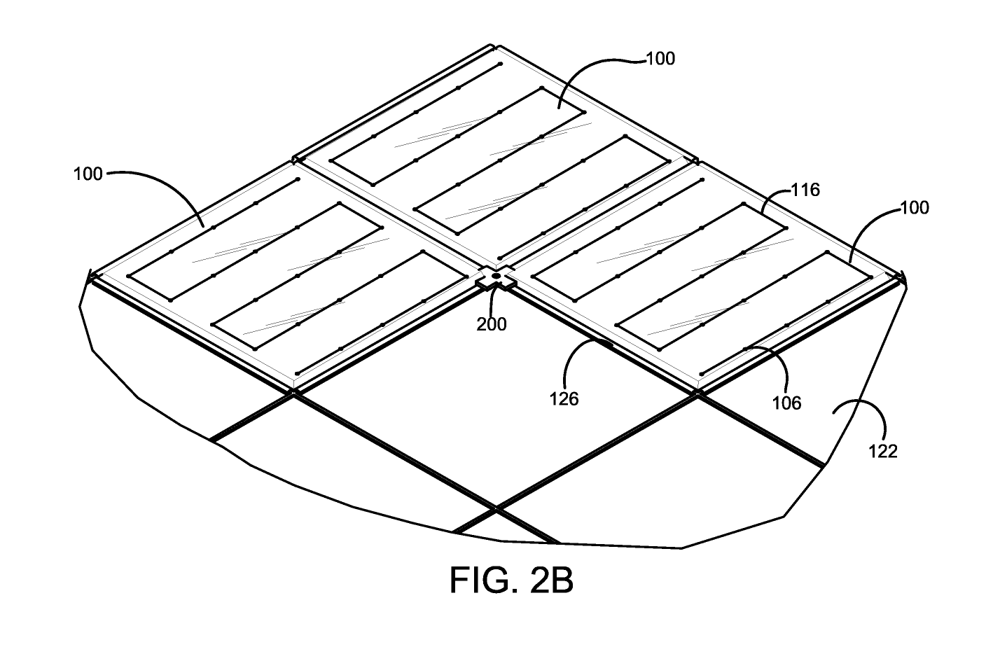

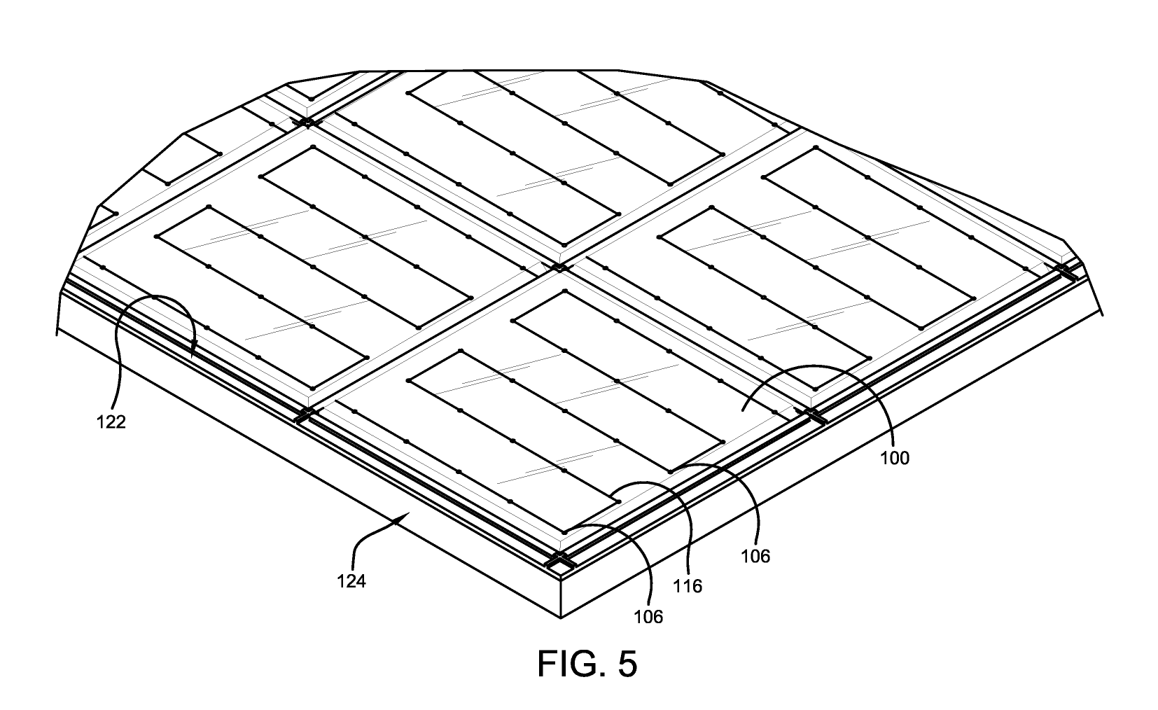

The plurality of LEDs 106 are in electrical communication with one another via at least one electrical trace 116 interconnecting the plurality of LEDs 106 in series (as shown in FIG. 3). In any given tile device 100, there is at least one electrical trace 116; however, any suitable number of electrical traces 116 can be used as is known in the art. Additionally, the illuminated tile device 100 comprises two sets of electrical contacts 118 (anode and cathode) positioned on a perimeter edge 120 of the base layer 102 to provide electrical continuity for the interconnection of multiple adjacent illuminated tile devices 100. Typically, the two sets of electrical contacts 118 comprise a total of four contacts 118 (two for the anode and two for the cathode) although any suitable number of electrical contacts 118 can be used. Thus, there may be electrical contacts 118 on all perimeter edges 120 of the illuminated tile device 100, and like electrical contacts 118 may be positioned opposite one another to enable complete uninterrupted electrical continuity from one side of the tile to the other (as shown in FIG. 6) thereby ensuring that rows and columns within arrays of interconnected illuminated tile devices 100 are electrically continuous (as shown in FIG. 6). Thus, the series-connected LEDs 106 can be connected between the anode and cathode sets of contacts 118 via the electrical traces 116, and given a rectangular tile device 100 with anode and cathode contacts 118 placed orthogonal to each other, the LEDs can be powered by energizing orthogonal edges of the tile. This layout allows tiles within an array either to be energized uniformly by applying pulse width modulated power to orthogonal edges of the entire array or to be energized individually by applying pulse width modulated power from a digital switching controller to individual rows and columns of the array.

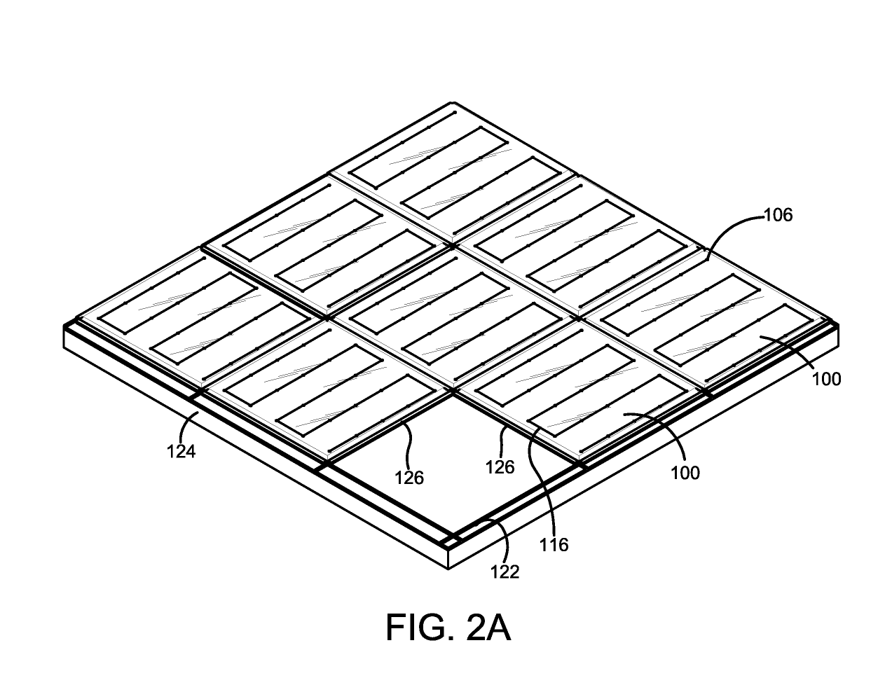

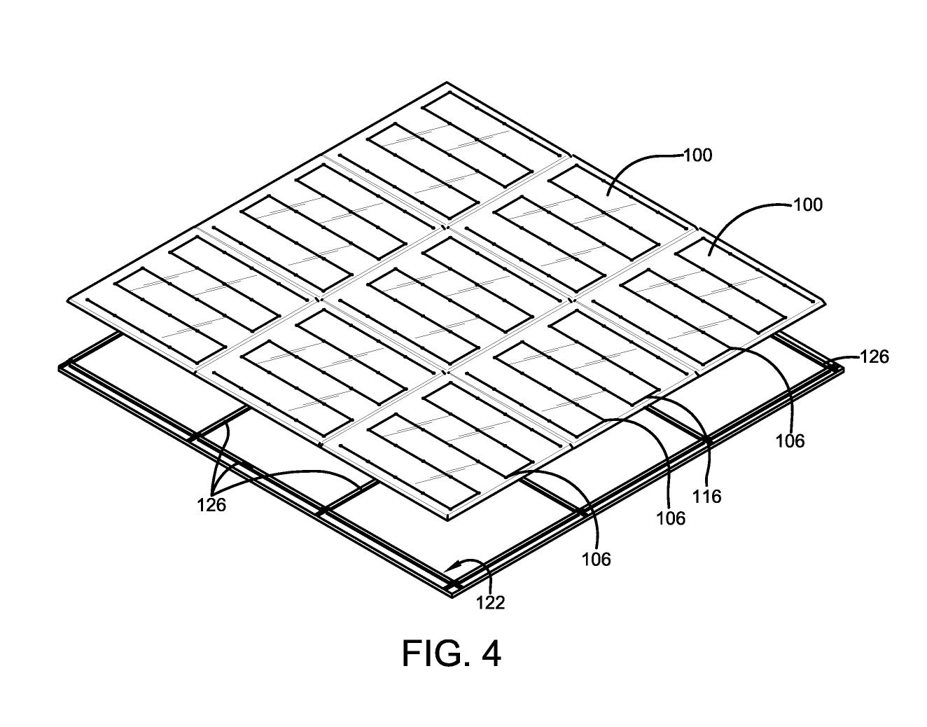

Furthermore, the illuminated tile devices 100 can be interconnected and secured together via any suitable securing means as is known in the art, (e.g., retaining clips, fasteners, or cement) to form an illuminated tile system. The plurality of illuminated tile devices 100 can also be interconnected by being inserted into a grid 122 (as shown in FIG. 5). The grid 122 can be manufactured of plastic, composite, or any other suitable material as is known in the art. The illuminated tile devices 100 can be arranged in the grid 122 to both align the devices 100 and hold the conductive contact clips 126 in place between the devices 100. The conductive contact clips 126 bridge the gaps between the illuminated tile devices 100 and are used to complete connections between the adjacent device 100 edges. The conductive contact clips 126 would typically be manufactured of metal such as copper or any other suitable conductive material as is known in the art. The illuminated tile devices 100 can be removably or permanently secured in the grid 122. Tile devices 100 that are removably secured in the grid 122 allow for the easy removal and replacement of tile devices 100 that may be damaged or defective. For example, the illuminated tile devices 100 can be snapped into the grid 122 and removably secured via screwing the retaining clips 200 in place (as shown in FIG. 2B), or the illuminated tile devices 100 can be permanently secured to the grid 122 via an adhesive, glue, or other suitable securing material that is allowed to cure (as shown in FIG. 2A). If retaining clips 200 are used, the retaining clips 200 work by holding down the contact clips 126 which, in turn, hold down the tile devices 100. The grid 122 can then be cemented, glued, or otherwise attached to a solid surface 124 via any suitable securing means.

Furthermore, the illuminated tile system requires a power supply and/or controller. A simple pulse-width-modulation controller could be connected between orthogonal edges of a tile array (as shown in FIG. 6) thereby supplying the same pulse-width-modulated power to the entire tile array. Alternatively, a more sophisticated digital switching controller could be connected to the tile array via separate electrical paths for individual rows and columns so that switching rows and columns in a strategically timed fashion could independently energize individual tiles. Using either method, the power supply and/or controller would convert standard residential AC power into pulse-width-modulated DC power used to control the brightness and/or pattern of the tile array. The power supply and controller components may be integrated together as one unit, or the components may be separate entities possessing suitable interconnection and communication interfaces.

Additionally, the illuminated tile devices 100 can be set up with various control schemes depending on the installation required. For example, a switching current source or current regulator circuit can be placed per row of tile devices 100 within a tile array, or one current limiter can be installed in each tile device 100 to limit current draw (as shown in FIG. 6). If a switching current source or current regulator circuit is installed per row of tile devices 100, then current draw is limited on a row-by-row basis and column timing must be controlled to ensure the right amounts of current flow through each of the tile devices 100 for the right amounts of time. In contrast, the tile devices 100 could be manufactured with integral current limiters, and thus, there would no longer be any need for row-by-row current limiting or complicated timing schemes to ensure proper current draw for each tile device 100. The current limiters could be constant-current diodes, resistors, or any other electrical component that inherently stabilizes current flow. The tile devices 100 with integral current limiters could be used in a large array where all the tile devices 100 are energized at once (as shown in FIG. 6) but would only require one pulse-width-modulated controller 300 with only two wires going to the whole array instead of a plurality of wires.

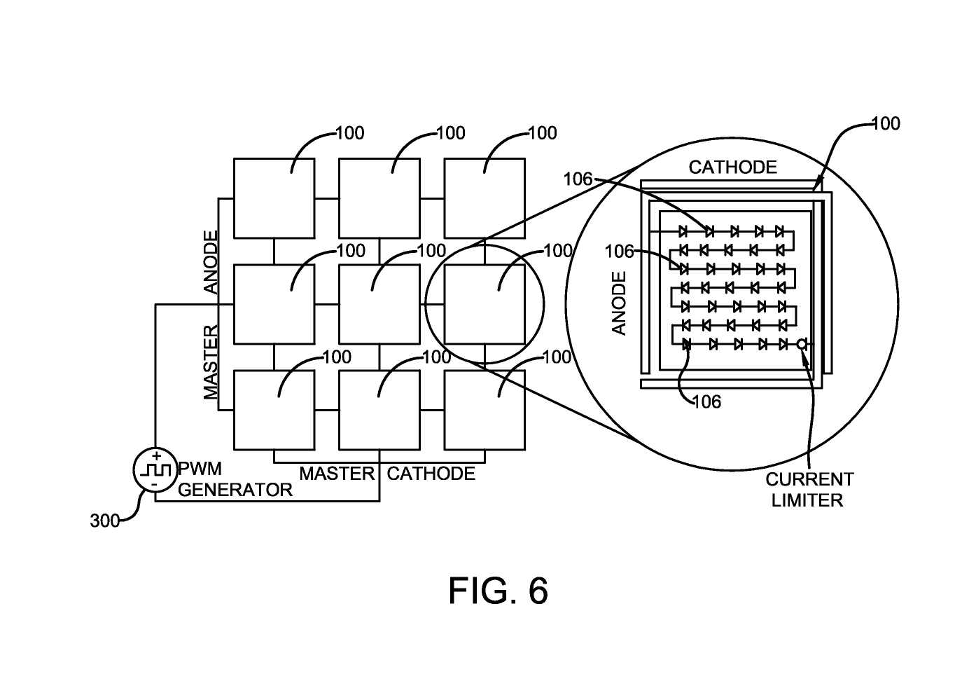

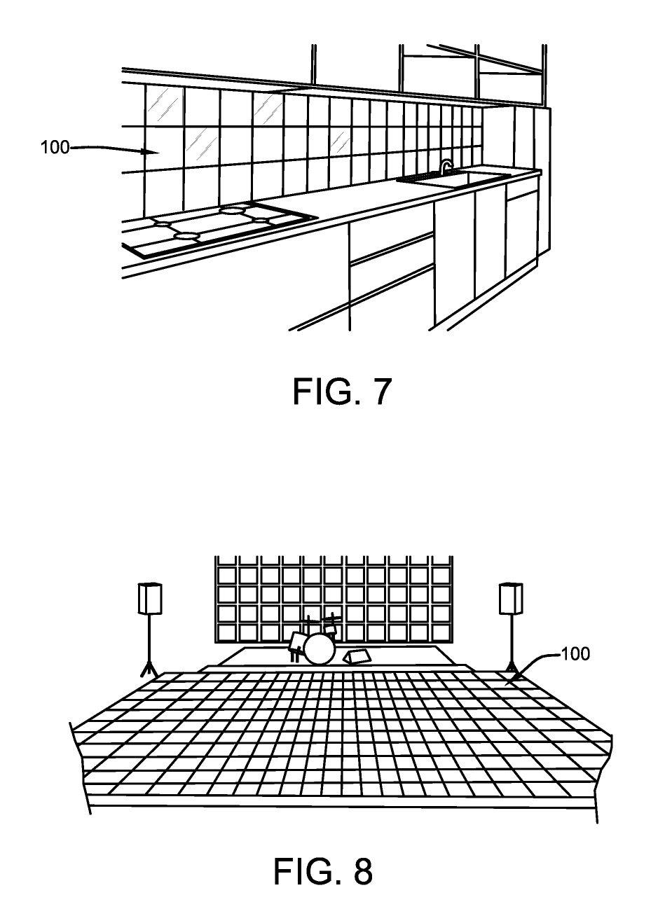

FIGS. 7-8 illustrate the illuminated tile device 100 in use. For any given installation, an user (not shown) would choose the size, shape, and/or design of the illuminated tile devices 100 that meets their needs and/or wants. The user would then ensure that the floor, wall, or other solid surface 124 is level and free of lumps, cracks, holes, gaps, etc. If there are any cracks, holes, gaps, etc., the user should fill these with a suitable putty or filler. After conditioning the surface 124 to be tiled, the user would roll out or lay out the grid 122, take measurements, and cut the proper amount of grid 122 needed to fit the desired area.

If more than one piece of grid 122 material is needed to achieve the desired coverage area, then the user must take care to ensure that seams between adjacent grid pattern pieces are properly aligned thereby ensuring that the overall grid pattern remains continuous and uniform. The user then fastens the grid 122 to the floor, wall, or other solid surface 124 via cement or any other suitable securing means as is known in the art. After cementing the grid 122 down, the user places contact clips 126 on all of the raised edges of the grid 122. The user also places special contact clips accommodating wire connections along at least two of the outermost orthogonal edges of the illuminated tile array to provide a place for wiring hookup.

Once the contact clips 126 are in place, the user places the illuminated tile devices 100 into the grid 122. The illuminated tile devices 100 can be snapped in and removably secured via screwing the retaining clips in place, or the illuminated tile devices 100 can be permanently secured to the grid 122 via an adhesive or glue that is allowed to cure. Once the tiles are secured, the user connects the wires to the special contact clips and routes the wires to a controller. The user then places the wires behind a trim board, or neatly routes the wires elsewhere for aesthetic reasons. Finally, the user then fills in the gaps between the illuminated tile devices 100 with grout, epoxy filler, silicone sealant, or any other suitable filler material.

The illuminated tile devices 100 can be used as decorative accents virtually anywhere tiles can be reasonably installed (e.g., floors, tiled walls, countertops, etc.). Further, the illuminated tile devices 100 can be interfaced with a controller that causes the tiles to light up in rhythmic patterns synchronized with music. These synchronized illuminated tile devices 100 can be used in bowling alleys, restaurants, mall floors, bars, dance floors, etc. The illuminated tile devices 100 can also be dimmed to provide night lighting along floors and other low-lit areas to enhance the safety of occupants.

What has been described above includes examples of the claimed subject matter. Of course, describing every conceivable combination of components or methodologies for purposes of describing the claimed subject matter is not possible, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, the term is intended to be inclusive in a manner similar to the term “comprising” as “comprising” is interpreted when employed as a transitional word in a claim.

What is claimed is:

1. An illuminated tile device comprising:
a base layer comprising a first end portion, a second end portion, opposing sides, a top surface, and a bottom surface;
a top layer comprising a first end portion, a second end portion, opposing sides, a top surface, and a bottom surface; and
a plurality of light emitting diodes (LEDs) positioned on the top surface of the base layer, and wherein the bottom surface of the top layer is positioned over the plurality of LEDs; and
wherein the plurality of LEDs are in electrical communication with each other, with an optional current limiting device, and with a power supply source.

2. The illuminated tile device of claim 1, further comprising at least one electrical trace interconnecting the plurality of LEDs in series.

3. The illuminated tile device of claim 2, further comprising at least two sets of electrical contacts, both an anode contact set and a cathode contact set positioned on a perimeter edge of the base layer.

4. The illuminated tile device of claim 3, wherein the illuminated tile device is connected to a second illuminated tile device via one of the two sets of electrical contacts, enabling electrical continuity between the devices.

5. The illuminated tile device of claim 4, wherein the illuminated tile device is secured adjacent to the second illuminated tile device and wherein electrical continuity is established between the first and second illuminated tile devices with the contact clip.

6. The illuminated tile device of claim 1, further comprising a filler material inserted between the top layer and the base layer to bond the top layer and base layer together.

7. The illuminated tile device of claim 6, wherein the plurality of LEDs, associated traces, and optional current limiting device are embedded within the filler material to form a matrix between the base layer and the top layer.

8. The illuminated tile device of claim 1, wherein the base layer and the top layer are manufactured of transparent material and are cemented together thereby sandwiching the plurality of LEDs, associated traces, and optional current limiting device.

9. The illuminated tile device of claim 1, wherein a plurality of illuminating tile devices are inserted into a grid to form an array.

10. The illuminated tile device of claim 9, wherein the grid is secured to a solid surface.

11. The illuminated tile device of claim 10, further comprising a controller and a pulse-width-modulator electrically connected to outer edges of the array for supplying, regulating, and modulating power to the array.

12. An illuminated tile device comprising:
a base layer comprising a first end portion, a second end portion, opposing sides, a top surface, and a bottom surface;
a top layer comprising a first end portion, a second end portion, opposing sides, a top surface, and a bottom surface; and
a plurality of light emitting diodes (LEDs) positioned on the top surface of the base layer, wherein the bottom surface of the top layer is positioned over the plurality of LEDs;
at least one electrical trace interconnecting the plurality of LEDs in series along with an optional current limiting device; and
at least two sets of electrical contacts positioned on a perimeter edge of the base layer.

13. The illuminated tile device of claim 12, further comprising a filler material inserted between the top layer and the base layer to bond the top layer and base layer together.

14. The illuminated tile device of claim 13, wherein the plurality of LEDs, associated traces, and optional current limiting device are embedded within the filler material to form a matrix between the base layer and the top layer.

15. The illuminated tile device of claim 14, wherein the base layer and the top layer are manufactured of transparent material and are cemented together thereby sandwiching the plurality of LEDs.

16. The illuminated tile device of claim 12, wherein the illuminated tile device is connected to a second illuminated tile device via one of the two sets of electrical contacts, enabling electrical continuity between the devices.

17. The illuminated tile device of claim 16, wherein the illuminated tile device is secured adjacent to the second illuminated tile device and wherein electrical continuity is established between the first and second illuminated tile devices with the contact clip.

18. The illuminated tile device of claim 17, wherein a plurality of illuminating tile devices are inserted into a grid to form an array.

19. The illuminated tile device of claim 18, further comprising a controller and a pulse-width-modulator electrically connected to outer edges of the array for supplying, regulating, and modulating power to the array.

20. An illuminated tile system comprising:
a plurality of interconnected illuminated tile devices inserted into a grid;
wherein each of the interconnected illuminated tile devices comprises:
a base layer comprising a first end portion, a second end portion, opposing sides, a top surface, and a bottom surface;
a top layer comprising a first end portion, a second end portion, opposing sides, a top surface, and a bottom surface; and
a plurality of light emitting diodes (LEDs) positioned on the top surface of the base layer, and wherein the bottom surface of the top layer is positioned over the plurality of LEDs; and
at least one electrical trace interconnecting the plurality of LEDs in series along with an optional current limiting device; and
at least two sets of electrical contacts positioned on a perimeter edge of the base layer.
